(19) United States
(12) Patent Application Publication
(10) Pub. No.: US 2009/0234990 A1
(43) Pub. Date: Sep. 17, 2009

(54) KVM SWITCH SYSTEM SUPPORTING DVI VIDEO FORMAT

(75) Inventors: Fu-Chin Shen, Keelung City (TW); Kuo-Chan Chien, Sijhih City (TW)

Correspondence Address: YING CHEN;Chen Yoshimura LLP, 255 S. GRAND AVE., # 215, LOS ANGELES, CA, 90012, US

(73) Assignee: ATEN INTERNATIONAL CO., LTD., Taipei (TW)

(21) Appl. No.: 12/046,205

(22) Filed: Mar. 11, 2008

(51) Int. Cl. G06F 13/12

(52) U.S. Cl. 710/62

(57) ABSTRACT

A KVM (keyboard, video, mouse) switch system includes a console module and multiple computer modules connected to the console module in series. Each computer module is connected to its upstream module by two Category 5 cables. Video signals are transmitted between the modules as digital video signals in the DVI format. A computer is connected to each computer module, and a user console is connected to the console module for selectively control one of the computers. The console module controls the computer modules so that one of them is in a connect mode and transmits video and keyboard/mouse signals between its attached computer and its upstream module, and all other computer modules are in a connect mode and pass video and keyboard/mouse signals between their upstream and downstream modules. By this configuration, digital video signals can be transmitted from computers at a large distance away from the user console.

### BACKGROUND OF THE INVENTION

1. Field of the Invention

This invention relates to KVM (Keyboard, Video, Mouse) switch systems, and in particular, it relates to KVM switch systems that transmit video signals between console module and computer modules using the DVI (Digital Visual Interface) format.

2. Description of the Related Art

Conventional KVM (Keyboard, Video, Mouse) switch systems include a central switch to which user consoles and computers are connected. Another type of KVM switch system has a de-centralized system, as illustrated in FIG. 1, where a number of compact modules (sometimes referred to as dongles) are connected in series without a central switch. A console module 11 is connected to a user console 14 including a monitor and a keyboard and/or mouse. A first computer module 12a is connected to the console module; a second computer module 12b is connected to the first computer module, a third computer module 12c is connected to the second computer module, etc. Each computer module 12 (12a, 12b, etc.) is connected to a computer 13 (13a, 13b, etc.), collectively referred to as a stage. The computer module operates to either transmit data between its upstream computer module and its downstream computer module, or transmit data between its upstream computer module and its attached computer. Here, “upstream” means closer to the condole module and “downstream” means the opposite. The console module 11 controls the computer modules 12 so that at most one computer module will transmit data between its upstream computer module and its attached computer, and all other computer modules will simply pass data between its upstream and downstream computer modules. As a result, the console 14 can interact with and control a selected one of the computers 13 (13a, 13b, etc.). Another computer 13z may be connected to the console module 11 directly and be controlled by the console 14.

The connections between the computer modules 12 and between the console module 11 and the first computer module are single Cat.5 (Category 5) connections 15. Keyboard and mouse signals and analog video signals are transmitted over the single Cat.5 cable 15.

### SUMMARY OF THE INVENTION

Accordingly, the present invention is directed to a KVM switch system and related method that substantially obviate one or more of the problems due to limitations and disadvantages of the related art.

An object of the present invention is to provide a KVM switch system including a console module and a plurality of computer modules connected in series, where video data is transmitted between stages using a digital format such as DVI. This allows the digital video signal to be transmitted over a large distance.

Another object of the present invention is to provide a KVM switch system that uses Cat.5 as a means to transmit DVI TMDS (transition minimized differential signaling) signals.

Another object of the present invention is to provide a console module and computer modules that can transmit video signals using digital format such as DVI.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a KVM switch system which includes: a first user console including a monitor and user input devices; a console module for connecting to the first user console; one or more computer modules connected in series to the console module, each computer module being connected to either an upstream computer module or to the console module, and connected to zero or more downstream computer modules; and zero or one computer connected to each computer module, wherein each computer module operates to either transmit video signals received from its connected computer to its upstream computer module or console module, or transmit video signals received from its downstream computer module to the its upstream computer module or console module, wherein the console module controls the computer modules so that at most one computer module transmits video signals received from its connected computer to its upstream computer module or console module, wherein the video signals transmitted among the computer modules and the console module are in a digital format. In one embodiment, the video signals are in a DVI format, and the video signals are transmitted between two computer modules and between one computer module and the console module by one or more Category 5 cables.

In another aspect, the present invention provides a method for communication within a KVM switch system, the KVM switch system including a first user console including a monitor and user input devices, a console module for connecting to the first user console, one or more computer modules, and zero or one computer, the method including: connecting the computer modules in series to the console module, each computer module being connected to either an upstream computer module or to the console module by a pair of Category 5 cables and connected to zero or more downstream computer modules by a pair of Category 5 cables; connecting zero or one computer to each computer module; each computer module either transmitting video signals received from its connected computer to its upstream computer module or console module, or transmitting video signals received from its downstream computer module to the its upstream computer module or console module; the console module controlling the computer modules so that at most one computer module transmits video signals received from its connected computer to its upstream computer module or console module, wherein the video signals transmitted among the computer modules and the console module are in a digital format.

In another aspect, the present invention provides a console module for a KVM switch system, which includes: a first and a second communication connector for connecting to a computer module by a pair of cables for communicating digital video signals, input device signals and control signals; a digital video signal output connector for connecting to a monitor of a first user console, the digital video signal output connector outputting digital video signals received from the first and second communication connectors; one or more user input device connectors for connecting to user input devices of the first user console; and processing circuitry connected to the user input device connectors and to at least the second communication connector, the processing circuit processing user input device signals received from the user input device connectors and transmitting them to the second communication connector. In one embodiment, the digital video signals are in a DVI format.

In yet another aspect, the present invention provides a computer module for a KVM switch system, which includes: a first and a second downstream communication connector for connecting to a downstream computer module by two cables for communicating digital video signals, input device signals and control signals; a first and a second upstream communication connector for connecting to an upstream computer module by two cables for communicating digital video signals, input device signals and control signals; a digital video signal input connector for connecting to a video port of a computer; a user input device signal connector for connecting to user input device ports of the computer; a switch circuit connected to the first and second downstream communication connectors, the digital video signal input connector and the first and second upstream communication connectors; and processing circuitry connected to the second upstream communication connector, the second downstream communication connector and the user input device signal connector, wherein the processing circuitry receives control signals from the second upstream communication connector and controls the computer module to operate in either a bypass mode or a connect mode, wherein in the bypass mode, the switch circuit transmits digital video signals received from the first and second downstream communication connectors to the first and second upstream communication connectors, respectively, and the processing circuitry transmits user input device signals received from the second upstream communication connector to the second downstream communication connector, and wherein in the connect mode, the switch circuit transmits digital video signals received from the digital video signal input connector to the first and second upstream communication connectors, and the processing circuitry transmits user input device signals received from the second upstream communication connector to the user input device signal connector.

In addition, some embodiments of the present invention allow a local console to be used to control a computer connected to a computer module. Some embodiments allow power to be transmitted over the Cat.5 cables, eliminating the need to provided separate power sources for the computer module. Some embodiments allow network-based control of the KVM system.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a conventional de-centralized KVM switch system.

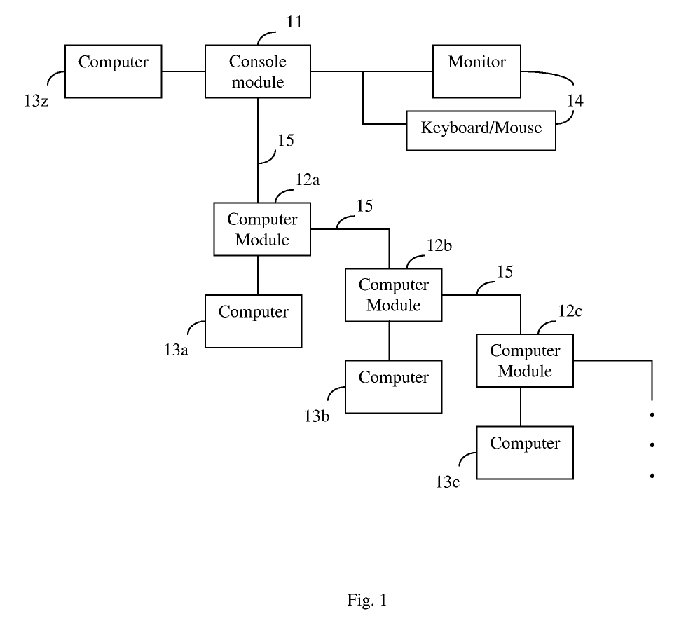

FIG. 2 illustrates a de-centralized KVM switch system according to an embodiment of the present invention.

FIG. 3 is a block diagram of a console module in the system of FIG. 2.

FIG. 4 is a block diagram of a computer module in the system of FIG. 2.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

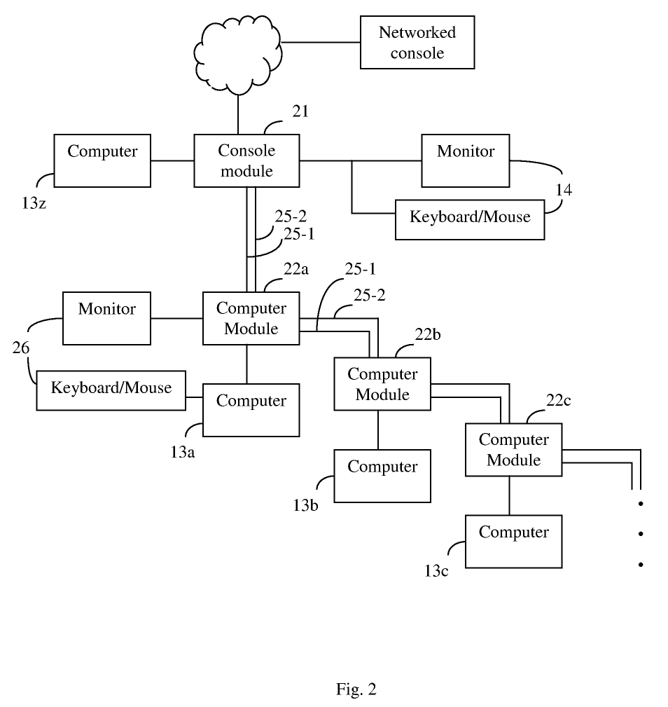

According to embodiments of the present invention, in a KVM switch system that includes a console module and a number of computer modules connected to the console module in series, video signals are transmitted as digital video signals between the console module and the computer modules as well as between adjacent computer modules. In one example, the video signals are transmitted using the DVI format. DVI (Digital Visual Interface) is a video interface standard designed to maximize the visual quality of digital display devices such as flat panel LCD computer displays and digital projectors. As illustrates in FIG. 2, the KVM switch system includes a console module 21 for connecting to a console 14 which includes a monitor and user input devices (such as a keyboard and/or mouse), and a plurality of computer modules 22 connected in series to the console module. The first computer module 22a is connected to the console module 21, and each additional computer module 22b, 22c, etc. is connected to an upstream computer module (here, “upstream” means closer to the console module). Each computer module 22 (22a, 22b, etc.) is connected to a computer 13 (13a, 13b, etc.), and operates to either transmit data between its upstream computer module and its downstream computer module, or transmit data between its upstream computer module and its attached computer. The console module 21 controls the computer modules 22 so that at most one computer module will transmit data between its upstream computer module and its attached computer, and all other computer modules will pass data between its upstream and downstream computer modules. As a result, the console 14 can interact with and control a selected one of the computers 13 (13a, 13b, etc.). The console module 21 and the connected series of computer modules constitute the KVM switch system.

Another computer 13z may be optionally connected to the console module 21 directly and be controlled by the console 14. Optionally, the console module 21 may be connected to a network and can be accessed by a networked console. In addition, any computer module 22 and its attached computer 13 (collectively referred to as a stage) may optionally have connected to it a local console 26 including a monitor and user input devices (such as a keyboard and/or mouse). In the embodiment illustrated in FIG. 2, the monitor of the local console 26 is connected to the computer module 22a, and the keyboard and/or mouse is connected to the computer 13a. Alternatively, as described later, the keyboard and/or mouse of the local console 26 may be connected to the computer module 22a. A switch is provided on the computer module 22a to allow the user to manually select either the local console 26 or the remote console 14 to control the computer 13a. (The console 14 is referred to as the remote console here because it is remote with respect to computer 13a.) When control is switched to the local console 26, the computer module 22a can pass signals between its upstream and downstream devices, but the remote console 14 cannot control the computer 13a even if the user at the remote console 14 selects the computer 13a to control.

In the illustrated embodiment, each computer module 22 is connected to its upstream computer module (or the console module 21 for the first computer module) by two communication cables 25-1 and 25-2 (such as Cat.5 cables), one for transmitting digital video signals (e.g. in the DVI format), the other for transmitting keyboard and mouse signals. In addition, one of the Cat.5 cables (preferably, the one that carries the keyboard and mouse signal) carries power to the computer module 22. In a preferred embodiment, the Cat.5 cable carries a 12V voltage. Thus, the computer module 22 can be powered independently of the attached computer 13 and does not need an external power source such as a plug-in power adapter. As a result, even if the computer 13 attached to the computer module 22 is not powered on, the computer module will still function to pass signals between its upstream and downstream computer modules.

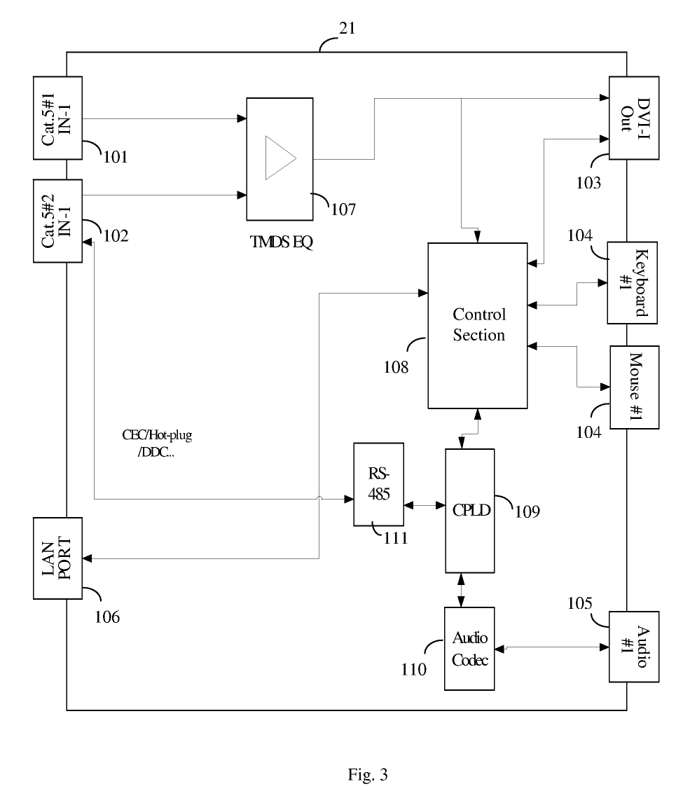

FIG. 3 is a block diagram of an exemplary console module 21. The console module has the following external connectors: a pair of Cat.5 connectors 101 and 102 each for receiving a Cat.5 cable, a digital video signal output connector 103 (a DVI connector in this embodiment) for connecting to the monitor of the console 14, one or more keyboard and/or mouse connectors 104 for connecting to a keyboard and/or mouse of the console 14, an optional audio connector 105 for connecting to audio devices such as speakers and/or microphones of the console 14, and an optional network port 106 for connecting to a network such as a local area network (LAN), wide area network (WAN), the Internet, etc. The keyboard and mouse connectors 104 may be PS/2 connectors, USB (universal serial bus) connectors, etc. depending on the keyboard and/or mouse used. The keyboard and mouse may have separate connectors or a combined connector depending on the keyboard and mouse used.

The signals transmitted on the Cat.5 cable connected to the first Cat.5 connector 101 will be digital video signals from the target computer (i.e. the one among the multiple computers 13a, 13b, etc. being controlled by the console 14). The digital video signals are processed by an equalizer circuit 107 which performs signal compensation. In a preferred embodiment, the video signals are transmitted using the TMDS (transition minimized differential signaling) technology and the equalizer circuit 107 is a TMDS equalizer. The equalizer 107 is optional, but is desired especially when the number of stages in the KVM system is large, when the digital video signals from the later stage may have become weak. The video signals from the equalizer 107 are outputted to the digital video signal output connector 103 to be transmitted to the monitor of the console 14. The keyboard and mouse signals received from the keyboard and/or mouse connectors 104 are processed by a control section 108 and sent to a logic circuit 109. The audio signals from the connector 105 are encoded by an audio codec 110 and sent to the logic circuit 109. The logic circuit 109 processes the keyboard, mouse and/or audio signals and packages them into packets. The logic circuit 109 is a CPLD (complex programmable logic device) in the illustrated example, but it may be any other suitable logic device such as FPGA (field-programmable gate array), etc. The packets containing keyboard, mouse and/or audio signals are processed by a transceiver circuit 111 and outputted to the second Cat.5 connector 102 to be transmitted to the target computer. Non-video signals may also be received on the second Cat.5 connector 102, such as audio signals for the speakers or certain signals for the keyboard or mouse. Such signals are received by the transceiver circuit 111, processed (unpackaged) by the logic circuit 109, and sent to the keyboard/mouse connectors 104 via the control section 108 or to the audio connector 105 after decoding by the codec 110. In addition, video signals received from the second Cat.5 connector 102 are also sent to the equalizer circuit 107. In this example, the first Cat.5 cable carries TMDS 0 to TMDS 3 signals and the second Cat.5 cable carries TMDS 4 to TMDS 6 and control signals.

The control section 108, which may be implemented by a microcontroller unit (MCU) or other suitable circuitry, controls the function of the KVM switch system. Using the console 14, the user interacts with the control section 108 to select which one of the computers 13 is to be controlled by the console. The control section 108 may include an OSD (on-screen display) circuit to generate on-screen menus to facilitate the interaction with the user. Video signals generated by the OSD circuit is outputted to the digital video signal output connector 103 to be displayed on the monitor of the console 14. The control section also generates control signals addressed to each of the computer modules 22. For example, the control signals instruct each computer module to either pass data between its upstream and downstream computer modules (referred to as the “bypass” mode) or transmit data between its upstream computer module and its attached computer (referred to as the “connect” mode). The control signals are processed by the logic circuit 109 and outputted to the second Cat.5 connector 102 to be transmitted to the computer modules 22.

The console module 21 may be optionally provided with a network-based remote access function. This function, sometimes referred to as IP-based KVM or IKVM, allows a remote console (not shown in FIG. 2) located on a network (e.g. a WAN, LAN, the Internet, etc.) to communicate with and control the KVM switch system using a network protocol (e.g. TCP/IP) as its communication protocol. Once logged in to the KVM switch system, the remote console can exchange keyboard, video and mouse signals with the KVM switch system and control the switch as if the remote console is directly connected to the console module 14. As illustrated in FIG. 3, the control section 108 of the console module 21 is connected to the network port 106. Keyboard and mouse signals from the remote console located on the network is received via the network port 106, processed by the control section 108, then processed by the logic circuit 109 and the transceiver 111 as described earlier, and outputted to the second Cat.5 connector 102 to be transmitted to the target computer. The video signals from the target computer received from the first Cat.5 connector 101 is processed by the equalizer circuit 107, and sent to the control section 108 to be transmitted to the network via the network port 106. Video signals for the OSD menu are also transmitted to the network via the network port 106. The control section 108 manages the logon control of the IKVM function.

A more detailed description of the control section 108 is omitted here, as the various functions of the control section 108 may be implemented by those skilled in the field of KVM switches using known techniques.

The exemplary console module 21 shown in FIG. 3 does not have the structures for connecting to the computer 13z (see FIG. 2). To accommodate the computer 13z, a video signal input port, one or more keyboard and/or mouse signal output ports, and various switch circuits for the video, keyboard and/or mouse, and audio signals are provided.

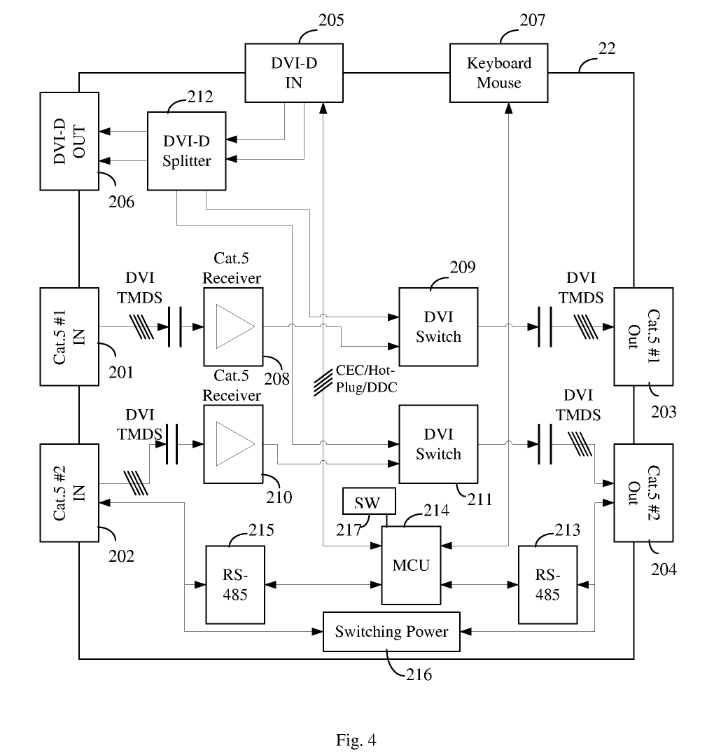

FIG. 4 is a block diagram of an exemplary computer module 22. The computer module has the following external connectors: a pair of downstream Cat.5 connectors 201 and 202, a pair of upstream Cat.5 connectors 203 and 204, a digital video signal input connector 205 (a DVI connector in this embodiment) for connecting to the video signals output port of the attached computer 13, a digital video signal output connector 206 (a DVI connector in this embodiment) for connecting to the monitor of the local console 26, and a keyboard and/or mouse signal connector 207 for connecting to the keyboard and/or mouse port of the attached computer 13. The downstream Cat.5 connectors 201 and 202 are for connecting to corresponding upstream Cat.5 connectors of the downstream computer module via two Cat.5 cables; the upstream Cat.5 connectors 203 and 204 are for connecting to corresponding downstream Cat.5 connectors of the upstream computer module or corresponding Cat.5 connectors 101 and 102 of the console module via two Cat.5 cables. The first downstream Cat.5 connector 201 and the first upstream Cat.5 connector 203 are for transmitting digital video signals; the second downstream Cat.5 connector 202 and the second upstream Cat.5 connector 204 are for transmitting keyboard and/or mouse signals (more generally, user input device signals), audio signals, control signals, power, etc.

As described earlier, each computer module in the KVM switch system is in either a bypass mode or a connect mode. When the computer module 22 is in the bypass mode, digital video signals received from the downstream computer module via the first downstream Cat.5 connector 201 are processed by a first Cat.5 receiver 208 and fed into a first switch circuit (a video switch) 209. The video switch 209 is switched to the Cat.5 receiver 208 in the bypass mode, and transmits the digital video signals from the downstream computer module to the first upstream Cat.5 connector 203. In addition, digital video signals received from the downstream computer module via the second downstream Cat.5 connector 202 are processed by a second Cat.5 receiver 210 and fed into a second video switch 211. The second switch 211 is switched to the Cat.5 receiver 210 in the bypass mode, and transmits the signals from the downstream computer module to the second upstream Cat.5 connector 204. The Cat.5 receivers 208 and 210 may perform signal compensation for the digital video signals. Non-video signals such as audio signals, etc. received from the downstream computer module via the second downstream Cat.5 connector 202 are processed by a second transceiver 215 and sent to a control section 214. The control section 214 may be implemented by an MCU. In the bypass mode, the control section 214 passes the signals from the second transceiver 215 to a first transceiver 213, which outputs them to the second upstream Cat.5 connector 204.

When the computer module 22 is in the connect mode, video signals from the attached computer 13 received via the digital video signal input connector 205 is forwarded by a video signal splitter 212 to the first and second switch circuits 209 and 211. In FIG. 4, two lines are shown between the digital video signal input connector 205 and the video signal splitter 212 (as well as between the video signal splitter 212 and the digital video signal output connector 206), which represent two sets of Cat.5 transmission lines, one for carrying TMDS 0 to TMDS 3 signals and the other for carrying TMDS 4 to TMDS 6 and control signals. The switch circuits 209 and 211 are switched to the video signal splitter 212 in the connect mode, so that the video signals from the computer 13 connected to this computer module, rather than the video signals from the downstream computer module, are transmitted to the upstream computer module.

In both modes, the signals received from the upstream computer module via the second upstream Cat.5 connector 204, including keyboard and/or mouse signals, audio signals, control signals, etc., originating from the remote console 14 and the console module 21 are processed by the first transceiver circuit 213 and sent to the control section 214. In the bypass mode, the control section 214 passes these signals to the second transceiver 215, which outputs them to the second downstream Cat.5 connector 202 to be transmitted to the downstream computer module. In the connect mode, the control section 214 processes the keyboard and/or mouse signals, the audio signals, etc. from the first transceiver 213 and sends them to the keyboard and/or mouse signal connector 207 to be transmitted to the attached computer 13. As a result, in the connect mode, the keyboard and/or mouse signals and audio signals from the remote console 14 are sent to the computer 13 attached to this computer module 22 to control this computer.

In both the bypass and the connect mode, the control signals from the second upstream Cat.5 connector 204 are passed by the first transceiver 213, the control section 214 and the second transceiver 215 to the second downstream Cat.5 connector 202 so that they can be received by downstream computer modules. In addition, control signals addressed to this computer module 22 are processed by the control section 214 and stored as appropriate, so that the control section 214 can control the operation of the computer module 22 according to the control signals. Moreover, a power section 216 is connected to the second upstream Cat.5 connector 204, and uses the power carried in the signals to supply power to various components of the computer module 22. The power circuit 216 may include a transformer and other components. The power signal from the second upstream Cat.5 connector 204 is also passed down to the second downstream Cat.5 connector 202 to be sent to the downstream computer modules.

The switching of the switch circuits 209 and 211 are controlled by the control section 214 based on the control signals received from the console module 21. (The connection lines between the control section 214 and the switch circuits 209 and 211 are not shown in FIG. 4 to avoid overcrowding.) The switching of the two switch circuits 209 and 211 is synchronized, i.e., they are either both switched to the video signal splitter 212 or both switched to the Cat.5 receiver circuits 208 and 210. Further, as explained above, the switching of the switch circuits 209 and 211 is consistent with the forwarding action of the control section 214, i.e., in the bypass mode, the control section passes the keyboard and/or mouse signals from the upstream device to the downstream device and the switch circuits 209 and 211 pass the video signals from the downstream device to the upstream device, and in the connect mode, the control section transmits the keyboard and/or mouse signals from the upstream device to the attached computer and the switch circuits 209 and 211 transmits video signals from the attached computer to the upstream device.

Signals are also transmitted between the digital video signal input connector 205 and the control section 214, including DDC (Display Data Channel) and hot plug detect signals. These signals serve various functions related to the monitor, such as detecting the best resolution of monitor and detect whether a monitor is connected thereto.

To control the computer 13 attached to the computer module 22 with the local console 26 instead of the remote console 14, the video signal from the attached computer received on the digital video signal input connector 205 is sent by the video signal splitter 212 to the digital video signal output connector 206 to be displayed on the monitor of the local console 26. In the illustrated embodiment, the video signal splitter 212 splits the video signals and sends them to both the digital video signal input connector 205 and the switch circuits 209 and 211. Alternatively, the splitter 212 may be replaced by a switch that sends the video signals alternatively to either the digital video signal input connector 205 or the switch circuits 209 and 211. Further, the keyboard and/or mouse of the local console 26 are directly connected to the attached computer 13 (see FIG. 2), e.g., via a USB port of the computer 13. Alternatively, the keyboard and/or mouse of the local console 26 may be connected to the computer console 22. In a preferred embodiment, a user-accessible switch 217 is provided on the housing of the computer module 22 to allow the user to manually select either the local console 26 or the remote console 14 to control the attached computer 13. The user-accessible switch 217 is electrically connected to the control section 214, and based on a select signal from this user-accessible switch, the control section 214 determines whether the computer 13 is controlled by signals from the local console 26 or the remote console 14 (via the second upstream Cat.5 connector 204).

In the embodiment shown in FIGS. 2 and 4, the keyboard and/or mouse of the local console 26 is directly connected to the computer 13. Alternatively (not shown), the computer module 22 may be provided with a keyboard and/or mouse input port to receive the keyboard and/or mouse of the local console 26. The keyboard and/or mouse signals from the local keyboard and/or mouse will be processed by the control section 214, which will transmit them to the attached computer 13 if the user selects the local console 26 using the switch on the computer module housing.

The console module 21 in FIG. 3 is shown as having one set of video, keyboard and mouse connectors for connecting to one user console, and having one pair of Cat.5 connectors for connecting to one computer module. Alternatively (not shown), two or more sets of video, keyboard and mouse connectors may be provided for connecting to two or more user consoles, and two or more pairs of Cat.5 connectors may be provided for connecting to two or more computer modules in a matrix configuration. Appropriate matrix switching circuits for the video, keyboard and mouse signals may be provided to connect the each console to a selected computer. The implementation of such switching circuits is within the ability of those skilled in the field of KVM switches.

Using Cat.5 cables, the video and other signals as well as power can be transmitted between two computer modules located up to about 50 meters apart. The current estimate of a 50-meter limit is determined by the signal degradation of DVI signals in the cable. Multiple computer modules can be connected in series this way. As a result, digital video signals in the DVI format can be transmitted over a large distance not limited to the signal degradation of the DVI signal. It is currently estimated that up to 24 computer modules can be connected in series, limited by the ability of power delivery over Cat.5 cables. Thus, according to current estimate, the KVM switch system can have up to 24 computers located at up to 1200 meters maximum distance between the last computer and the console module without using additional power supplies. If a repeater device is connected between two stages to provide power and signal compensation, additional computer modules can be connected after the repeater. As a result, the DVI signals can be transmitted over an even larger distance.

Although the illustrated embodiment uses the DVI format for the video signal, other suitable digital video format may also be used, including those that may come into existence in the future. Further, Cat.5 cables and connectors are used in the illustrated embodiments. The dual-link configuration using a pair of Cat.5 cables shown in the embodiments has the advantage that it uses standard cables and connectors. However, other suitable transmission hardware and standards, including those that may come into existence in the future, may be used to transmit the digital video signals, keyboard and/or mouse signals and other signals between stages of the KVM system. In particular, although a pair of Cat.5 cables and pairs of connectors (such as 101 and 102, 201 and 202, 203 and 204) are used, they may be replaced by a single cable and single connectors if the cable is sufficient to transmit digital video signals and other relevant signals.

It will be apparent to those skilled in the art that various modification and variations can be made in the KVM switch system and method of the present invention without departing from the spirit or scope of the invention. Thus, it is intended that the present invention cover modifications and variations that come within the scope of the appended claims and their equivalents.

1. A KVM (keyboard, video, mouse) switch system comprising:
a first user console including a monitor and user input devices;
a console module for connecting to the first user console;
one or more computer modules connected in series to the console module, each computer module being connected to either an upstream computer module or to the console module, and connected to zero or more downstream computer modules; and
zero or one computer connected to each computer module,
wherein each computer module operates to either transmit video signals received from its connected computer to its upstream computer module or console module, or transmit video signals received from its downstream computer module to the its upstream computer module or console module,
wherein the console module controls the computer modules so that at most one computer module transmits video signals received from its connected computer to its upstream computer module or console module, and
wherein the video signals transmitted among the computer modules and the console module are in a digital format.

2. The KVM switch system of claim 1, wherein the video signals are in a DVI (Digital Visual Interface) format.

3. The KVM switch system of claim 2, wherein the video signals are transmitted between two computer modules and between one computer module and the console module by one or more Category 5 cables.

4. The KVM switch system of claim 3, wherein the cables have a length of up to 50 meters.

5. The KVM switch system of claim 4, wherein a total length of cables from the console module to a last computer module is up to 1200 meters.

6. The KVM switch system of claim 3, wherein the console module transmits power over the Category 5 cables to the computer modules.

7. The KVM switch system of claim 1, further comprising:
a computer connected to the console module; and
zero or one second user console connected to each computer module, each user console including a monitor and user input devices.

8. A console module for a KVM (keyboard, video, mouse) switch system, comprising:
a first and a second communication connector for connecting to a computer module by a pair of cables for communicating digital video signals, input device signals and control signals;
a digital video signal output connector for connecting to a monitor of a first user console, the digital video signal output connector outputting digital video signals received from the first and second communication connectors;
one or more user input device connectors for connecting to user input devices of the first user console; and
processing circuitry connected to the user input device connectors and to at least the second communication connector, the processing circuit processing user input device signals received from the user input device connectors and transmitting them to the second communication connector.

9. The console module of claim 8, wherein the digital video signals are in a DVI (Digital Visual Interface) format, and
wherein the console module further comprises a TMDS (transition minimized differential signaling) equalizer connected between the first communication connector and the digital video signal output connector for performing signal compensation for the digital video signals.

10. The console module of claim 9, wherein the first and second communication connectors are Category 5 connectors each for receiving a Category 5 cable.

11. The console module of claim 8, wherein the processing circuit includes a control section for processing the user input device signals, a logic circuit for packetizing the user input device signals into packets, and a transceiver circuit for transmitting the signals to the second communication connector.

12. The console module of claim 11, wherein the control section generates control signals for controlling one or more computer modules connected to the console module, wherein the logic circuit processes the control signals, and wherein the transceiver circuit transmits the control signals to the second communication connector.

13. The console module of claim 11, further comprising a network connector connected to the control section for interfacing with a network,
wherein the control section is operable to communicate with a second user console located on the network, to transmit digital video signals received from the first communication connector to the second user console over the network, and to process user input device signals received from the second user console over the network, and
wherein the logic circuit processes the input device signals and the transceiver circuit transmits the input device signals to the second communication connector.

14. A computer module for a KVM (keyboard, video, mouse) switch system, comprising:
a first and a second downstream communication connector for connecting to a downstream computer module by two cables for communicating digital video signals, input device signals and control signals;
a first and a second upstream communication connector for connecting to an upstream computer module by two cables for communicating digital video signals, input device signals and control signals;
a digital video signal input connector for connecting to a video port of a computer;
a user input device signal connector for connecting to user input device ports of the computer;
a switch circuit connected to the first and second downstream communication connectors,
the digital video signal input connector and the first and second upstream communication connectors; and
processing circuitry connected to the second upstream communication connector, the second downstream communication connector and the user input device signal connector,
wherein the processing circuitry receives control signals from the second upstream communication connector and controls the computer module to operate in either a bypass mode or a connect mode,
wherein in the bypass mode, the switch circuit transmits digital video signals received from the first and second downstream communication connectors to the first and second upstream communication connectors, respectively, and the processing circuitry transmits user input device signals received from the second upstream communication connector to the second downstream communication connector, and
wherein in the connect mode, the switch circuit transmits digital video signals received from the digital video signal input connector to the first and second upstream communication connectors, and the processing circuitry transmits user input device signals received from the second upstream communication connector to the user input device signal connector.

15. The computer module of claim 14, wherein the digital video signals are in a DVI (Digital Visual Interface) format, and
wherein the computer module further comprises a receiver circuit connected to the first and second downstream communication connectors for compensating the digital video signals.

16. The computer module of claim 14, wherein the first and second downstream communication connectors and the first and second upstream communication connectors are Category 5 connectors each for receiving a Category 5 cable.

17. The computer module of claim 14, further comprising a power section connected to the second upstream communication connector for supplying power to the computer module using power carried in signals received from the second upstream communication connector.

18. The computer module of claim 14, further comprising:
a digital video signal output connector for connecting to a monitor of a local user console; and
a digital video signal splitter coupled to the digital video signal input connector, the switch circuit, and the digital video signal output connector, the digital video signal splitter transmitting digital video signals received from the digital video signal input connector to both the switch circuit and the digital video signal output connector.

19. The computer module of claim 18, further comprising a user-accessible switch electrically connected to the control section for selecting either the local user console or the input device signals from the second upstream communication connector to control the computer.

20. The computer module of claim 14, wherein the digital video signal input connector is connected to the processing circuitry for communicating display data channel and hot plug detect signals.
